(19) United States
(12) Patent Application Publication
(10) Pub. No.: US 2013/0272472 A1
(43) Pub. Date: Oct. 17, 2013

(54) MOLTEN-CORE RETENTION STRUCTURE

(71) Applicants: Kazuyoshi AOKI, Kanagawa (JP); Mika Tahara, Kanagawa (JP); Ken Okuda, Kanagawa (JP); Yasunobu Fujiki, Kanagawa (JP); Hisaki Sato, Kanagawa (JP)

(72) Inventors: Kazuyoshi AOKI, Kanagawa (JP); Mika Tahara, Kanagawa (JP); Ken Okuda, Kanagawa (JP); Yasunobu Fujiki, Kanagawa (JP); Hisaki Sato, Kanagawa (JP)

(21) Appl. No.: 13/647,887

(22) Filed: Oct. 9, 2012

Related U.S. Application Data
(63) Continuation-in-part of application No. PCT/JP2011/002032, filed on Apr. 6, 2011.

(30) Foreign Application Priority Data
Apr. 23, 2010 (JP) 2010-100119

(51) Int. Cl. G21C 9/016

(52) U.S. Cl. CPC G21C 9/016
USPC 376/280

(57) ABSTRACT

According to an embodiment, a molten-core retention structure comprises the following inside a reactor vessel that contains a reactor core: a bottom support plate, in which vertically penetrating flow holes are formed, that is provided beneath the core and supports the core; a bottom support plate support that is affixed to the reactor vessel and supports the bottom support plate; a thermally insulating spacer; a reticulated heat path that is affixed to the bottom support plate support with the thermally insulating spacer interposed therebetween and contacts the bottom support plate; and vertical heat paths that extend downwards from the reticulated heat path. The reticulated heat path and the vertical heat paths have higher coefficients of thermal conductivity than the thermally insulating spacer.

### CROSS REFERENCES TO RELATED APPLICATIONS

This application is a continuation-in-part (CIP) application based upon the International Application PCT/JP2011/002032, the International Filing Date of which is Apr. 6, 2011, the entire content of which is incorporated herein by reference, and claims the benefit of priority from the prior Japanese Patent Application No. 2010-100119, filed in the Japanese Patent Office on Apr. 23, 2010, the entire content of which is incorporated herein by reference.

### FIELD

Embodiments described herein relates to a molten-core retention structure that retains a molten core inside a reactor vessel containing a reactor core.

### BACKGROUND

In a water-cooled reactor, when cooling water is lost due to stop of water supply into the reactor pressure vessel or due to a rupture of a pipe connected to the reactor pressure vessel, the reactor water level may lower to expose the reactor core, resulting in insufficient cooling of the reactor core. If such a case occurs, the reactor is automatically emergency-stopped when a water level low signal is detected, and then coolant is injected by the emergency core cooling system to flood the reactor core with water for cooling to thereby prevent a core meltdown accident. However, a case may occur, although with extremely low probability, where the emergency core cooling system does not work and the water injection system for injecting water into the reactor core cannot be utilized. In such a case, the reactor core is exposed due to lowering of the reactor water level to cause insufficient cooling of the reactor core with a result that the fuel rod temperature rises due to decay heat, finally resulting in core meltdown.

If such a situation occurs, the high-temperature molten core falls down to the lower portion of the reactor pressure vessel, melts and penetrates the reactor pressure vessel lower head, and finally falls onto the floor in the containment vessel. The molten core heats up concrete spread on the containment vessel floor and reacts with the concrete to generate large quantity of non-condensable gas, such as carbon dioxide and hydrogen, while melting and eroding the concrete if the temperature of the contact surface is high. The generated non-condensable gas may pressurize and damage the reactor containment vessel and may damage a containment vessel boundary by melting erosion of concrete.

If the molten core can be retained in the pressure vessel, the reaction between the molten core and the concrete and the like need not be taken into consideration. As a typical method of retaining and cooling the molten core in the reactor pressure vessel, there is known a method called IVR (In-Vessel Retention). In this method, the reactor vessel is externally flooded with cooling water to remove heat transferred from the molten core by boiling heat transfer of the cooling water and to cool and condense generated steam in the containment vessel. Then, the condensed water returns to a portion around the reactor vessel. Thus, the molten core that has fallen to the reactor vessel lower portion and the reactor vessel itself are cooled to prevent damage of the reactor vessel and leakage of the molten core into the containment vessel occurring as a result of the damage of the reactor vessel.

In order to achieve the IVR, it is necessary to prevent the reactor pressure vessel from being damaged due to heat transferred from the molten core to the reactor pressure vessel. To this end, there exists a method of preventing melting and damage of the reactor pressure vessel by spreading a heat resistant material on an inner surface portion of the reactor pressure vessel at which the heat transferred from the molten core concentrates to restrict the heat to be transferred to the reactor pressure vessel. Further, there is another method of preventing melting and damage of the reactor pressure vessel by mixing fine particles in the cooling water to enhance cooling performance.

### BRIEF DESCRIPTION OF THE DRAWINGS

The above and other features and advantages of the present invention will become apparent from the discussion hereinbelow of specific, illustrative embodiments thereof presented in conjunction with the accompanying drawings, in which:

FIG. 1 is an elevational cross-sectional view of a reactor using a first embodiment of a molten-core retention structure according to the present invention, taken along line I-I of FIG. 2 as viewed in the direction of the arrows;

FIG. 2 is a horizontal cross-sectional view taken along line II-II of FIG. 1 as viewed in the direction of the arrows;

FIG. 3 is an elevational cross-sectional view of a portion around a thermally insulating spacer in the first embodiment of the molten-core retention structure according to the present invention;

FIG. 4 is a perspective view illustrating a part of a reticulated heat path, the thermally insulating spacer, and fastening bolts in the first embodiment of the molten-core retention structure according to the present invention;

FIG. 5 is an elevational cross-sectional view of a reactor using a second embodiment of the molten-core retention structure according to the present invention;

FIG. 6 is an elevational cross-sectional view of a reactor using a third embodiment of the molten-core retention structure according to the present invention;

FIG. 7 is an elevational cross-sectional view illustrating a vicinity of a connection portion between a reticulated heat path and a bottom support plate support in a fourth embodiment of the molten-core retention structure according to the present invention;

FIG. 8 is an elevational cross-sectional view illustrating a vicinity of a connection portion between the reticulated heat path and a bottom support plate support in a fifth embodiment of the molten-core retention structure according to the present invention;

FIG. 9 is a horizontal cross-sectional view of a reactor vessel in a sixth embodiment of the molten-core retention structure according to the present invention;

FIG. 10 is a horizontal cross-sectional view of a reactor vessel in a seventh embodiment of the molten-core retention structure according to the present invention; and

FIG. 11 is an elevational cross-sectional view of the reactor vessel in the seventh embodiment of the molten-core retention structure according to the present invention.

### DETAILED DESCRIPTION

A main problem that we face when trying to retain the molten core in the reactor pressure vessel is a high heat flux which is generated in a metal layer to be formed in the molten core deposited at the reactor vessel lower portion. In a case where the molten core is retained at the reactor vessel lower portion, the oxide and the metal constituting the molten core may be separated from each other to be deposited in a layered manner. When the molten core is separated into the oxide layer and the metal layer, heat generated in the molten core concentrates on the metal layer having a comparatively high thermal conductivity, so that the heat flux at the position at which the metal layer is formed may significantly be increased. When the high heat flux at the position at which the metal layer is formed exceeds the cooling performance, the reactor vessel may be damaged.

In a case where the reactor pressure vessel is to be prevented from being damaged by the high heat flux generated at the position at which the metal layer is formed by spreading the heat resistant material around the metal layer formation position, it is highly uncertain where the metal layer is formed, and it is difficult to estimate the metal layer formation position with certainty. Further, in the method of mixing the fine particles in the cooling water, if the amount of the metal contained in the molten core is considerably small, heat flux at a level exceeding the effect of increasing the cooling performance, which is obtained by the mixing of the fine particles, is generated at the metal layer formation position. Such an incident may cause the reactor pressure vessel to be damaged.

An object of the embodiments is therefore to reduce, in a case where the reactor core has been melted, a possibility that the reactor vessel is damaged by the high heat flux which is generated at the position within the reactor vessel at which the metal layer is formed.

In order to achieve the object, according to an aspect of the present invention, there is provided a molten-core retention structure comprising: a reactor vessel containing a reactor core; a bottom support plate provided below the reactor core so as to support the reactor core and having vertically penetrating flow holes formed therein; a bottom support plate support fixed to the reactor vessel so as to support the bottom support plate; a thermally insulating spacer; and a heat path structure including: a support plate contacting portion fixed to the bottom support plate support through the thermally insulating spacer so as to contact the bottom support plate, and a vertical transfer portion extending downward from the support plate contacting portion, the heat path structure having a thermal conductivity higher than thermal conductivity of the thermally insulating spacer.

According to another aspect of the present invention, there is provided a molten-core retention structure comprising: a reactor vessel containing a reactor core; a bottom support plate provided below the reactor core so as to support the reactor core and having vertically penetrating flow holes formed therein; a bottom support plate support fixed to the reactor vessel so as to support the bottom support plate; and a heat path structure including: a plurality of vertical transfer portions extending downward from the flow holes, and a horizontal transfer portion contacting an upper surface of the bottom support plate and connecting the plurality of vertical transfer portions.

According to another aspect of the present invention, there is provided a molten-core retention structure comprising: a reactor vessel containing a reactor core; a bottom support plate provided below the reactor core so as to support the reactor core and having vertically penetrating flow holes formed therein; weirs formed so as to be raised from an upper surface of the bottom support plate and to surround the flow holes; and a bottom support plate support fixed to the reactor vessel so as to support the bottom support plate.

According to the present embodiments, it is possible to reduce, in a case where the reactor core has been melted, a possibility that the reactor vessel is damaged by the high heat flux which is generated at the position within the reactor vessel at which the metal layer is formed.

Embodiments of a molten-core retention structure according to the present invention will be described with reference to the accompanying drawings. Throughout the drawings, the same reference numerals are used to designate the same or similar component parts, and redundant descriptions are omitted.

### First Embodiment

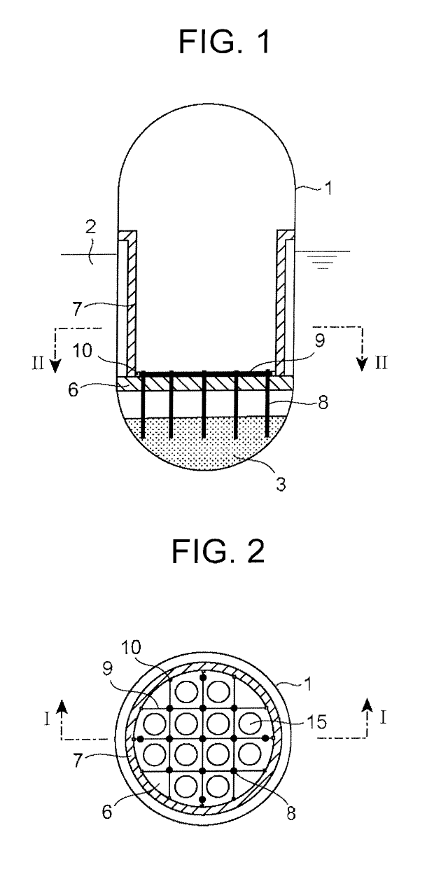

FIG. 1 is an elevational cross-sectional view of a reactor using a first embodiment of a molten-core retention structure according to the present invention, taken along line I-I of FIG. 2 as viewed in the direction of the arrows. FIG. 2 is a horizontal cross-sectional view taken along line II-II of FIG. 1 as viewed in the direction of the arrows.

The molten-core retention structure includes a reactor vessel 1 containing a reactor core, a bottom support plate 6, a bottom support plate support 7, a thermally insulating spacer 10, and a heat path structure constituted by vertical heat paths 8 and a reticulated heat path 9, and retains the molten core in the reactor vessel 1. The reactor vessel 1 is formed into a vertically extending cylinder extending with its both ends each closed by a semispherical head. During normal operation time, cooling water is heated by heat generated by the reactor core in the reactor vessel 1 to generate steam, and the generated steam is used to rotate a not-illustrated turbine for electric power generation.

The bottom support plate 6 is provided below the reactor core in the reactor vessel 1 so as to support the reactor core. The bottom support plate 6 is a horizontally extending plate in which a plurality of vertically penetrating flow holes 15 are formed.

The bottom support plate support 7 extends in a vertical direction inside the reactor vessel 1 from the outer periphery of the bottom support plate 6 and bends toward the inner surface of the reactor vessel 1 at its upper end. The bottom support plate support 7 is fixed to the reactor vessel 1 so as to support the bottom support plate 6.

The heat path structure is provided inside the reactor vessel 1 and includes a support plate contacting portion and a vertical transfer portion extending downward from the support plate contacting portion. The support plate contacting portion, which is the reticulated heat path 9, functions as a heat path that transfers heat in horizontal directions. The vertical transfer portion, which is the vertical heat paths 8, functions as a heat path that transfers heat in the vertical direction.

The reticulated heat path 9 is formed into a reticulated shape on an upper surface of the bottom support plate 6 so as to contact the upper surface of the bottom support plate 6. The reticulated heat path 9 is fixed to the bottom support plate support 7 through the thermally insulating spacer 10.

The vertical heat paths 8 extend downward from the reticulated heat path 9, penetrating the bottom support plate 6. The vertical heat paths 8 are connected to the reticulated heat path 9. The reticulated heat path 9 and the vertical heat paths 8 are each formed of a material, such as tungsten, having a high melting point and a high thermal conductivity. In place of the reticulated heat path 9, a thin plate having the same shape as that of the bottom support plate 6 may be used.

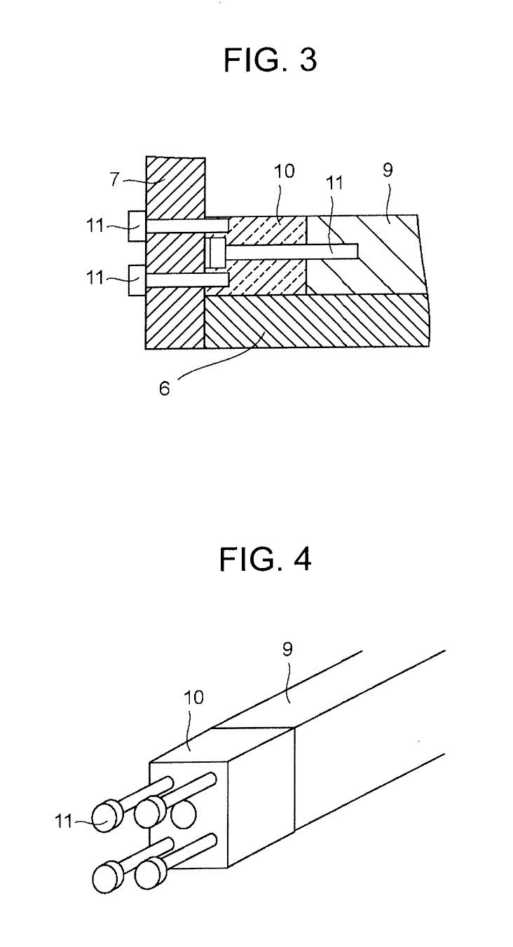

FIG. 3 is an elevational cross-sectional view of a portion around the thermally insulating spacer in the present embodiment. FIG. 4 is a perspective view illustrating a part of the reticulated heat path, a thermally insulating spacer, and fastening bolts in the present embodiment.

The reticulated heat path 9 is in contact with the upper surface of the bottom support plate 6, and is fixed to the thermally insulating spacer 10 by fastening bolts 11. The thermally insulating spacer 10 is fixed to the bottom support plate support 7 by different fastening bolts 11. The fastening bolts 11 fastening the reticulated heat path 9 and the thermally insulating spacer 10 do not contact the bottom support plate support 7. The thermally insulating spacer 10 is formed of a material having a high melting point such as an oxide including alumina, for example.

If, in the reactor having such a molten-core retention structure, the reactor core is insufficiently cooled due to stop of water supply into the reactor vessel 1 to result in core meltdown, a high temperature molten core 3 falls down to a lower portion of the reactor vessel 1 through the flow holes 15 of the bottom support plate 6. At this time, the reactor vessel 1 is externally flooded with cooling water 2 to remove heat transferred from the molten core 3 by boiling heat transfer of the cooling water 2 and to cool and condense generated steam in a containment vessel. And then, the condensed water returns to a portion around the reactor vessel 1. Thus, the molten core 3, which has fallen down to the lower portion of the reactor vessel 1, and the reactor vessel 1 itself are cooled to prevent damage of the reactor vessel 1 and leakage of the molten core 3 into the containment vessel occurring as a result of the damage of the reactor vessel 1.

Providing the amount of the reactor core to be melted is small and the molten core 3 supported at the lower portion of the reactor vessel 1 does not contact the bottom support plate 6, heat of the molten core 3 is transferred to the vertical heat paths 8 through direct contact between the molten core 3 and the vertical heat paths 8. The heat transferred to the vertical heat paths 8 is transferred by heat conduction to the reticulated heat path 9 and the bottom support plate 6. This allows the bottom support plate 6 to be melted and fall down to the molten core 3.

In a case where the molten core is retained at the lower portion of the reactor vessel 1, the oxide and the metal constituting the molten core may be separated from each other to be deposited in a layered manner. When the molten core is separated into an oxide layer and a metal layer, heat generated in the molten core concentrates on the metal layer having a comparatively high thermal conductivity, so that the heat flux at the position at which the metal layer is formed may be significantly increased. However, in the present embodiment, melting the bottom support plate 6 increases the amount of the metal in the molten core 3 deposited at the lower portion of the reactor vessel 1. As a result, the thickness of the metal layer of the molten core 3 deposited at the lower portion of the reactor vessel 1 is increased to thereby suppress concentration of the heat generated in the molten core, which can reduce a possibility that the reactor vessel 1 is damaged.

The heat is transferred also to the bottom support plate support 7 through the reticulated heat path 9. However, the reticulated heat path 9 and the bottom support plate support 7 are connected to each other through the thermally insulating spacer 10, so that the thermal conductivity of the thermally insulating spacer 10 is lower than those of the vertical heat paths 8 and the reticulated heat path 9. Thus, the heat of the molten core 3 is less likely to be transferred to the bottom support plate support 7, so that it is unlikely that the bottom support plate support 7 is melted. If the bottom support plate support 7 is not melted, the reticulated heat path 9 and vertical heat paths 8 do not fall down to the molten core 3 but are supported by the bottom support plate support even if the entire bottom support plate 6 is melted.

### Second Embodiment

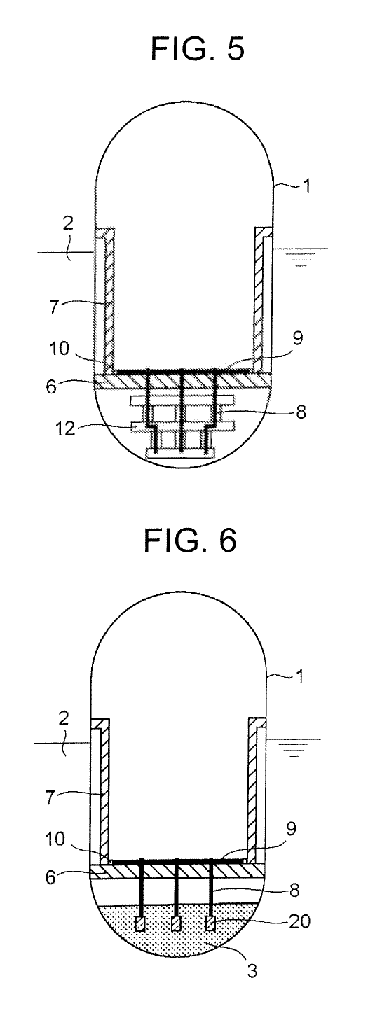

FIG. 5 is an elevational cross-sectional view of a reactor using a second embodiment of the molten-core retention structure according to the present invention.

In the present embodiment, the vertical heat paths 8 are fixed to the surface of a bottom head structure 12 which is disposed at the lower end of the reactor vessel 1. The vertical heat paths 8 may be embedded in the bottom head structure 12.

Even in such a molten-core retention structure, providing the amount of the molten core is small and the molten core 3 (see FIG. 1) supported at the lower portion of the reactor vessel 1 does not contact the bottom support plate 6, the bottom support plate 6 is allowed to be melted and fall down to the molten core 3. As a result, the thickness of the metal layer of the molten core 3 deposited at the lower portion of the reactor vessel 1 is increased to thereby suppress concentration of the heat generated in the molten core, which can reduce a possibility that the reactor vessel 1 is damaged.

Further, in the present embodiment, the vertical heat paths 8 are embedded in the bottom head structure 12, so that the vertical heat paths 8 do not directly contact the reactor vessel 1 to suppress heat from being transferred to the reactor vessel 1. This also reduces a possibility that the reactor vessel 1 is damaged.

### Third Embodiment

FIG. 6 is an elevational cross-sectional view of a reactor using a third embodiment of the molten-core retention structure according to the present invention.

In the present embodiment, the lower ends of the vertical heat paths 8 are covered with high melting-point thermally insulating materials 20. The thermally insulating materials 20 are formed of a high melting point material having a thermal conductivity lower than that of the vertical heat paths 8, such as oxide such as alumina (aluminum oxide) or zirconia (zirconium oxide).

Even in such a molten-core retention structure, providing the amount of the reactor core to be melted is small and the molten core 3 supported at the lower portion of the reactor vessel 1 does not contact the bottom support plate 6, the bottom support plate 6 is allowed to be melted and fall down to the molten core 3. As a result, the thickness of the metal layer of the molten core 3 deposited at the lower portion of the reactor vessel 1 is increased to thereby suppress concentration of the heat generated in the molten core, which can reduce a possibility that the reactor vessel 1 is damaged.

Further, in the present embodiment, even if the vertical heat paths 8 have fallen down to the molten core 3, the vertical heat paths 8 contact the reactor vessel 1 through the thermally insulating material 20, so that the vertical heat paths 8 do not directly contact the reactor vessel 1 to suppress heat from being transferred to the reactor vessel 1. This also reduces a possibility that the reactor vessel 1 is damaged.

### Fourth Embodiment

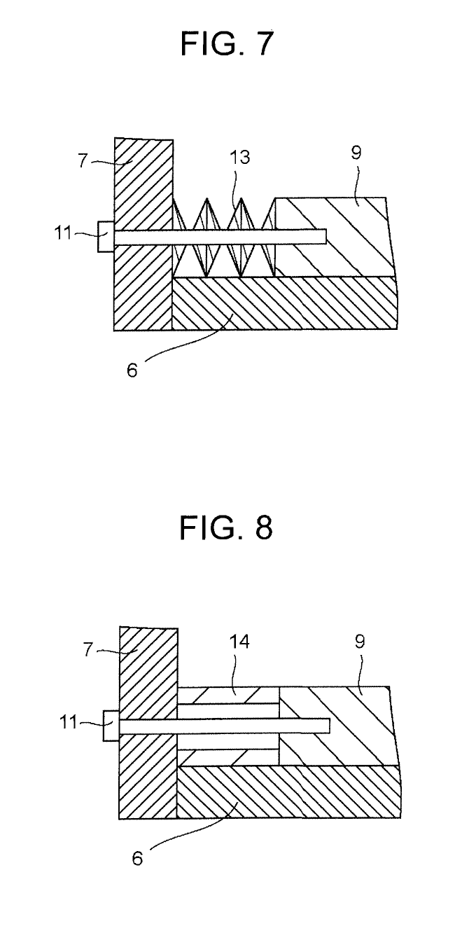

FIG. 7 is an elevational cross-sectional view illustrating a vicinity of a connection portion between the reticulated heat path and the bottom support plate support in a fourth embodiment of the molten-core retention structure according to the present invention.

In the present embodiment, the reticulated heat path 9 and the bottom support plate support 7 are connected not by the thermally insulating spacer 10 used in the first embodiment (see FIG. 3) but by fastening bolts 11 each having a disk spring 13. The disk spring 13 part has a cross section considerably smaller than that of the heat path structure such as the reticulated heat path 9 and therefore has a reduced thermal conductivity.

Even in such a molten-core retention structure, providing an amount of the reactor core to be melted is small and the molten core 3 (see FIG. 1) supported at the lower portion of the reactor vessel 1 does not contact the bottom support plate 6, the bottom support plate 6 is allowed to be melted and fall down to the molten core 3. As a result, the thickness of the metal layer of the molten core 3 deposited at the lower portion of the reactor vessel 1 is increased to thereby suppress concentration of the heat generated in the molten core, which can reduce a possibility that the reactor vessel 1 is damaged.

Further, the thermal conductivity at the connection portion between the reticulated heat path 9 and the bottom support plate support 7 is lower than that of the heat path structure such as the reticulated heat path 9. Thus, the heat of the molten core 3 is less likely to be transferred to the bottom support plate support 7, so that it is unlikely that the bottom support plate support 7 is melted. If the bottom support plate support 7 is not melted, the reticulated heat path 9 and the vertical heat paths 8 do not fall down to the molten core 3 but are supported by the bottom support plate support even if the entire bottom support plate 6 is melted.

Further, connecting the reticulated heat path 9 and the bottom support plate support 7 by the fastening bolts 7 having the disk springs 13 reduces a possibility that the bottom support plate support 7 is melted due to direct contact between the reticulated heat path 9 and the bottom support plate support 7. Further, the disk springs 13 provided at the connection portions absorb heat expansion of the reticulated heat path 9.

### Fifth Embodiment

FIG. 8 is an elevational cross-sectional view illustrating a vicinity of a connection portion between the reticulated heat path and the bottom support plate support in a fifth embodiment of the molten-core retention structure according to the present invention.

In the present embodiment, spacers 14 are used in place of the thermally insulating spacers 10 (see FIG. 3) used in the first embodiment. Each of the spacers 14 of the present embodiment is a hollow cylinder. The reticulated heat path 9 and the bottom support plate support 7 are connected to each other by fastening bolts 11 penetrating hollow portions of the spacers 14. Forming the spacers 14 into the hollow cylinders reduces the cross section thereof as compared with that of the reticulated heat path 9, thereby increasing thermal resistance.

Even in such a molten-core retention structure, providing the amount of the molten core is small and the molten core 3 (see FIG. 1) supported at the lower portion of the reactor vessel 1 does not contact the bottom support plate 6, the bottom support plate 6 is allowed to be melted and fall down to the molten core 3. As a result, the thickness of the metal layer of the molten core 3 deposited at the lower portion of the reactor vessel 1 is increased to thereby suppress concentration of the heat generated in the molten core, which can reduce a possibility that the reactor vessel 1 is damaged.

Further, the thermal conductivity at the connection portion between the reticulated heat path 9 and the bottom support plate support 7 is lower than that of the heat path structure such as the reticulated heat path 9. Further, thermal contact resistance occurs at contact portions between the reticulated heat path 9 and the spacers 14 and contact portions between the spacers 14 and the bottom support plate support 7. Thus, the heat of the molten core 3 is less likely to be transferred to the bottom support plate support 7 to reduce a possibility that the bottom support plate support 7 is melted. If the bottom support plate support 7 is not melted, the reticulated heat path 9 and the vertical heat paths 8 do not fall down to the molten core 3 but are supported by the bottom support plate support even if the entire bottom support plate 6 is melted.

### Sixth Embodiment

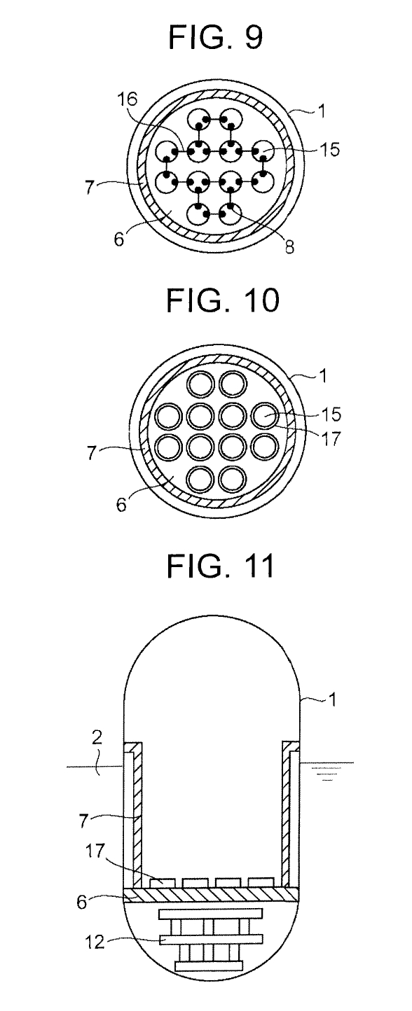

FIG. 9 is a horizontal cross-sectional view of a reactor vessel in a sixth embodiment of the molten-core retention structure according to the present invention.

In the present embodiment, the vertical heat paths 8 are fixed to the outer edges of the flow holes 15 formed in the bottom support plate 6 and extend downward penetrating the flow holes 15. Each of the vertical heat paths 8 is attached to its corresponding flow hole 15. The upper ends of the mutually adjacent vertical heat paths 8 are connected to each other by a horizontal heat path 16.

The vertical heat paths 8 fixed to the flow holes 15 are connected to the horizontal heat path 16, so that in a state where the molten core 3 (see FIG. 1) is retained at the lower portion of the reactor vessel 1, portions of the bottom support plate 6 between the flow holes are melted by heat transferred from the horizontal heat path 16. As a result, the adjacent flow holes 15 are joined together to allow a large part of the bottom support plate 6 to fall down to the lower portion of the reactor vessel 1 and to be melted.

Even in such a molten-core retention structure, providing the amount of the reactor core to be melted is small and the molten core 3 supported at the lower portion of the reactor vessel 1 does not contact the bottom support plate 6, the bottom support plate 6 is allowed to be melted and fall down to the molten core 3. As a result, the thickness of the metal layer of the molten core 3 deposited at the lower portion of the reactor vessel 1 is increased to thereby suppress concentration of the heat generated in the molten core, which can reduce a possibility that the reactor vessel 1 is damaged.

Further, in the present embodiment, the portions of the bottom support plate 6 between the flow holes 15 are melted and fall down, with the result that the vertical heat paths 8 and the horizontal heat path 16 are not supported by the bottom support plate 6. It follows that the vertical heat paths 8 and the horizontal heat path 16 fall down to the reactor vessel lower portion. Thus, it is preferable to cover the lower ends of the vertical heat paths 8 and the connection portion between the vertical heat paths 8 and the horizontal heat path 16 with thermally insulating material.

### Seventh Embodiment

FIG. 10 is a horizontal cross-sectional view of a reactor vessel in a seventh embodiment of the molten-core retention structure according to the present invention. FIG. 11 is an elevational cross-sectional view of the reactor vessel according to the present embodiment.

In the present embodiment, weirs 17 are formed so as to be raised from the upper surface of the bottom support plate 6 and to surround the flow holes 15 formed in the bottom support plate 6. The weirs 17 are formed along the edge of the flow holes 15. The weirs 17 are formed of high melting point material.

When the reactor core is melted and falls down to the lower portion of the reactor vessel 1, the molten core is once deposited on the bottom support plate 6. At this time, the weirs 17 formed of the high-melting point material suppress the molten core from falling to the lower portion of the reactor vessel 1 through the flow holes 15. As a result, melting of the bottom support plate 6 is accelerated by the heat transferred from the molten core 3 deposited on the bottom support plate 6.

Even in such a molten-core retention structure, the thickness of the metal layer of the molten core 3 deposited at the lower portion of the reactor vessel 1 is increased to thereby suppress concentration of the heat generated in the molten core, which can reduce a possibility that the reactor vessel 1 is damaged.

### Other Embodiments

The above embodiments are merely illustrative, and do not limit the present invention. Further, the features of the respective embodiments may be combined.

What is claimed is:

1. A molten-core retention structure comprising:
a reactor vessel containing a reactor core;
a bottom support plate provided below the reactor core so as to support the reactor core and having vertically penetrating flow holes formed therein;
a bottom support plate support fixed to the reactor vessel so as to support the bottom support plate;
a thermally insulating spacer; and
a heat path structure including: a support plate contacting portion fixed to the bottom support plate support through the thermally insulating spacer so as to contact the bottom support plate, and a vertical transfer portion extending downward from the support plate contacting portion, the heat path structure having a thermal conductivity higher than thermal conductivity of the thermally insulating spacer.

2. The molten-core retention structure according to claim 1, wherein
the support plate contacting portion is formed into a reticulated shape spreading over the bottom support plate.

3. The molten-core retention structure according to claim 1, wherein
the support plate contacting portion is a thin plate spreading over the bottom support plate.

4. The molten-core retention structure according to claim 1, further comprising a bottom head structure disposed at a lower end of the reactor vessel, wherein
the vertical transfer portion is fixed to the bottom head structure.

5. The molten-core retention structure according to claim 1, wherein
a lower end of the vertical transfer portion is covered with a thermally insulating material having a thermal conductivity lower than thermal conductivity of the vertical transfer portion.

6. The molten-core retention structure according to claim 1, wherein
the thermally insulating spacer includes a fastening bolt and a disk spring, the thermally insulating spacer connecting the support plate contacting portion and the bottom support plate support.

7. The molten-core retention structure according to claim 1, wherein
the thermally insulating spacer includes a fastening bolt and a spacer, the thermally insulating spacer connecting the support plate contacting portion and the bottom support plate support.

8. A molten-core retention structure comprising:
a reactor vessel containing a reactor core;
a bottom support plate provided below the reactor core so as to support the reactor core and having vertically penetrating flow holes formed therein;
a bottom support plate support fixed to the reactor vessel so as to support the bottom support plate; and
a heat path structure including: a plurality of vertical transfer portions extending downward from the flow holes, and a horizontal transfer portion contacting an upper surface of the bottom support plate and connecting the plurality of vertical transfer portions.

9. A molten-core retention structure comprising:
a reactor vessel containing a reactor core;
a bottom support plate provided below the reactor core so as to support the reactor core and having vertically penetrating flow holes formed therein;
weirs formed so as to be raised from an upper surface of the bottom support plate and to surround the flow holes; and
a bottom support plate support fixed to the reactor vessel so as to support the bottom support plate.

10. The molten-core retention structure according to claim 2, further comprising a bottom head structure disposed at a lower end of the reactor vessel, wherein
the vertical transfer portion is fixed to the bottom head structure.

11. The molten-core retention structure according to claim 2, wherein
a lower end of the vertical transfer portion is covered with a thermally insulating material having a thermal conductivity lower than thermal conductivity of the vertical transfer portion.

12. The molten-core retention structure according to claim 2, wherein
the thermally insulating spacer includes a fastening bolt and a disk spring, the thermally insulating spacer connecting the support plate contacting portion and the bottom support plate support.

13. The molten-core retention structure according to claim 2, wherein
the thermally insulating spacer includes a fastening bolt and a spacer, the thermally insulating spacer connecting the support plate contacting portion and the bottom support plate support.

14. The molten-core retention structure according to claim 3, further comprising a bottom head structure disposed at a lower end of the reactor vessel, wherein
the vertical transfer portion is fixed to the bottom head structure.

15. The molten-core retention structure according to claim 3, wherein
a lower end of the vertical transfer portion is covered with a thermally insulating material having a thermal conductivity lower than thermal conductivity of the vertical transfer portion.

16. The molten-core retention structure according to claim 3, wherein
the thermally insulating spacer includes a fastening bolt and a disk spring, the thermally insulating spacer connecting the support plate contacting portion and the bottom support plate support.

17. The molten-core retention structure according to claim 3, wherein
the thermally insulating spacer includes a fastening bolt and a spacer, the thermally insulating spacer connecting the support plate contacting portion and the bottom support plate support.
